(19) United States
(12) Patent Application Publication
(10) Pub. No.: US 2023/0241438 A1
(43) Pub. Date: Aug. 3, 2023

(54) ELECTRONIC DRY SPRINKLER ASSEMBLY

(71) Applicant: Tyco Fire Products LP, Lansdale, PA (US)

(72) Inventors: Robert M. Cordell, Providence, RI (US); Robert Hackett, Cranston, RI (US); Sean E. Cutting, West Warwick, RI (US); Ryan Gilbert McLaughlin, Warwick, RI (US)

(73) Assignee: Tyco Fire Products LP, Lansdale, PA (US)

(21) Appl. No.: 18/004,392

(22) PCT Filed: Aug. 25, 2021
(86) PCT No.: PCT/IB2021/057797

§ 371 Date: Jan. 5, 2023

Related U.S. Application Data
(60) Provisional application No. 63/073,651, filed on Sep. 2, 2020.

(51) Int. Cl. A62C 35/62; A62C 37/40; A62C 37/48

(52) U.S. Cl. CPC A62C 35/62; A62C 37/40; A62C 37/48

(57) ABSTRACT

A sprinkler system includes a fitting, at least one tube, at least one fluid distribution device, and an actuator. The fitting connects with at least one pipe, defines an opening, and includes a seal. The seal has a closed state in which the seal seals the opening and an open state in which the seal does not seal the opening to allow fluid flow from the at least one pipe through the opening. The at least one tube connects with the fitting on an opposite side of the seal from the at least one pipe. The fluid distribution device is connected with the at least one tube. The actuator receives a detection signal indicative of a trigger condition and causes the seal to change from the closed state to the open state to allow the fluid flow through the opening responsive to receiving the detection signal.

### CROSS-REFERENCE TO RELATED APPLICATIONS

The present application claims the benefit of and priority to U.S. Provisional Application No. 63/073,651, filed Sep. 2, 2020, the disclosure of which is incorporated herein by reference in its entirety.

### BACKGROUND

Fire sprinklers can be used to output fluids to address fire conditions. Some fire sprinklers can be implemented in dry pipe systems, in which fluid (e.g., water) is not present in at least a portion of the piping upstream of the fire sprinkler, such as to avoid freezing.

### SUMMARY

At least one aspect relates to a sprinkler. The sprinkler can include a fitting, a seal, at least one tube, a fluid distribution device, and an actuator. The fitting connects with at least one pipe and defines an opening. The seal has a closed state in which the seal seals the opening and an open state in which the seal does not seal the opening to allow fluid flow from the at least one pipe through the opening. The at least one tube connects with the fitting on an opposite side of the seal from the at least one pipe. The fluid distribution device is connected with the at least one tube. The actuator receives a detection signal indicative of a trigger condition and causes the seal to change from the closed state to the open state to allow the fluid flow through the opening responsive to receiving the detection signal.

At least one aspect relates to a sprinkler system. The sprinkler system can include a fitting, at least one tube, at least one fluid distribution device, a detector, and an actuator. The fitting defines an opening and includes a seal. The seal has a closed state in which the seal seals the opening and an open state in which the seal does not seal the opening to allow fluid flow from the at least one pipe through the opening. The at least one tube connects with the fitting downstream from the at least one pipe. The at least one fluid distribution device connects with the at least one tube. The detector monitors at least one parameter of an environment around the sprinkler assembly and outputs a detection signal responsive to the at least one parameter satisfying a trigger condition. The actuator receives the detection signal and causes the seal to change from the closed state to the open state to allow the fluid flow through the opening responsive to receiving the detection signal.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts a schematic diagram of an example of a sprinkler system.

FIG. 2 depicts a schematic diagram of an example of a fitting and electronic control system of a sprinkler system.

FIG. 3 depicts a schematic diagram of an example of a fitting and electronic control system of a sprinkler system.

FIG. 4 depicts a schematic diagram of an example of a fitting and electronic control system of a sprinkler system.

FIG. 5 depicts a schematic diagram of an example of a fitting and electronic control system of a sprinkler system.

FIG. 6 depicts a schematic diagram of an example of a fitting and electronic control system of a sprinkler system.

### DETAILED DESCRIPTION

Following below are more detailed descriptions of various concepts related to, and implementations of electronic flexible hose dry sprinklers, assemblies, systems, and methods. Dry sprinkler systems can be used in various implementations in which it is useful to avoid filling piping or tubing to the sprinkler with fluid until a fire condition is present. The various concepts introduced above and discussed in greater detail below can be implemented in any of numerous ways.

Sprinkler systems can be installed in various locations, such as buildings, in which fluid is outputted by sprinklers to address fire conditions. Some sprinkler systems are at least partially dry, such that gases, such as air or nitrogen, are present in piping (e.g., piping or tubing) between a fluid supply and the sprinklers. For example, dry sprinkler systems can be installed in situations in which at least a portion of the system can be exposed to freezing temperatures, to prevent fluid in the piping from freezing.

It can be useful for sprinkler systems, including dry sprinkler systems, to be installed in a manner in which the position of the sprinklers relative to piping components can be adjusted during installation. For example, flexible tubing, such as a flexible hose, can be provided to connect a sprinkler to upstream components, such as to piping that has a more fixed position, to enable flexibility in the positioning of the sprinkler (and reduce constraints on structural materials between the piping and the sprinkler), including to position the tubing through multiple turns and around studs and other rigid structures.

Systems and methods in accordance with the present application can improve sprinkler systems by using an electronic trigger for opening an upstream, sealed portion of the system. For example, such systems can have improved reliability of operation (including where the system is installed where the ambient temperature around the sprinkler and flexible hose can be below freezing) and flexibility in the positioning of the sprinkler that is connected with the flexible hose, such as by avoiding the need for a mechanical linkage to cause the sealed portion to open. The system can include a fitting, at least one tube, at least one fluid distribution device, and an actuator. The fitting connects with at least one pipe, defines an opening, and includes a seal. The seal has a closed state in which the seal seals the opening and an open state in which the seal does not seal the opening to allow fluid flow from the at least one pipe through the opening. The at least one tube connects with the fitting on an opposite side of the seal from the at least one pipe. The fluid distribution device connects with the at least one tube. The actuator receives a detection signal indicative of a trigger condition and causes the seal to change from the closed state to the open state to allow the fluid flow through the opening. The detection signal can be received from a detector that detects the trigger condition and outputs the detection signal responsive to detecting the trigger condition, such as a fire detector, gas detector, temperature sensor, heat detector, or smoke detector. For example, the trigger condition can correspond to a value of a parameter (or change in value of parameter) that meets or exceeds a threshold value, such as temperature, gas concentration, particulate concentration, or smoke concentration. The threshold value can be calibrated to indicate a fire condition (e.g., a value expected to be indicative of a fire).

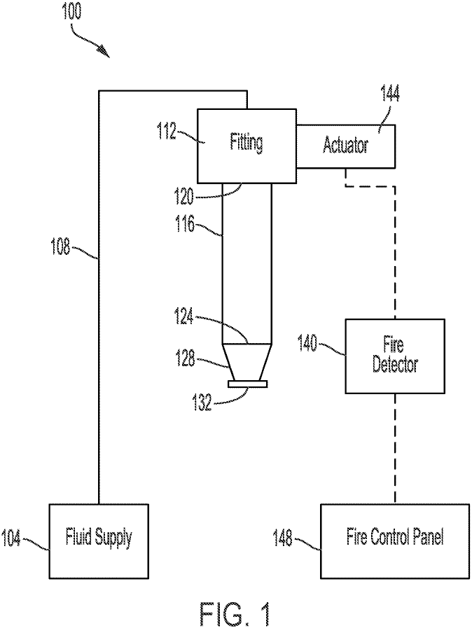

FIG. 1 depicts an example of a sprinkler system 100. The sprinkler system 100 can be implemented as a dry sprinkler system. The sprinkler system 100 can include a fluid supply 104. The fluid supply 104 can store fluids to be used to address a fire condition, which can include at least one of water and one or more fire suppression agents.

The sprinkler system 100 can include one or more pipes 108. The pipes 108 can be connected with the fluid supply 104 and extend from the fluid supply 104. The pipes 108 can extend through a structure, such as a building. Fluid from the fluid supply 104 can be present in the pipes 108 and flow through the pipes 108. The pipes 108 can include any of a variety of conduits that can be used to flow fluid, including but not limited to piping, tubing, metal pipes, rigid pipes, or polymeric (e.g., chlorinated polyvinyl chloride (CPVC)) pipes.

The sprinkler system 100 can include a fitting 112. The fitting 112 can be used to selectively allow fluid to flow from the pipes 108 into downstream components of the sprinkler system 100 (e.g., for output by sprinklers). For example, the fitting 112 can be a valve that is actuated from a closed state to an open state responsive to receiving a control signal as described herein.

The sprinkler system 100 can include at least one tube 116 extending from an inlet tube end 120 to an outlet tube end 124. The inlet tube end 120 can connect with the fitting 112 to receive fluid from the fitting 112 while the fitting 112 is in an open state. The tube 116 can be flexible. For example, at least one of a position and an orientation of the outlet tube end 124 can be adjusted relative to the inlet tube end 120. The tube 116 can be a flexible hose. The at least one tube 116 can include a rigid member (e.g., pipe, such as a dry barrel pipe) connected downstream of the flexible hose.

The sprinkler system 100 can include at least one fluid distribution device 128 connected with the outlet tube end 124 of the at least one tube 116. The fluid distribution device 128 can be a sprinkler or a nozzle. For example, the fluid distribution device 128 can be an open sprinkler or nozzle (e.g., a device that has an open flow path from an inlet to an outlet when the device is installed, such as by not including a seal between the inlet and the outlet). The fluid distribution device 128 can include a deflector 132 that causes fluid received through the at least one tube 116 to be outputted according to a target spray pattern.

The sprinkler system 100 can include at least one detector 140. The detector 140 can monitor parameters in an environment around the fluid distribution device 128 to detect a trigger condition for triggering operation of actuator 144. The detector 140 can include various detectors, such as temperature detectors, heat detectors, gas detectors, or smoke detectors. The detector 140 can detect a value of the parameter or a rate of change of the parameter, compare the value to a corresponding threshold, and output the detection signal responsive to the value satisfying a trigger condition, such as a minimum threshold. For example, the detector 140 can sense at least one of a temperature and a rate of change of temperature. The detector 140 can detect the fire condition responsive to at least one of the temperature meeting or exceeding a threshold temperature and the rate of change meeting or exceeding a threshold rate of change. The detector 140 can include multiple detectors (e.g., a temperature sensor and a gas concentration sensor), and determine the trigger condition to be satisfied responsive to a weighted evaluation of multiple parameters (e.g., comparing temperature to a temperature threshold and gas or smoke concentration to a gas or smoke concentration threshold).

The detector 140 can output a control signal (e.g., detection signal) to an actuator 144 coupled with the fitting 112 to cause the actuator 144 to cause the fitting 112 to change from the closed state to the open state, allowing fluid to flow through the tube 116 and out of the fluid distribution device 128. The detector 140 can include a local power supply, such as a battery backup, to maintain operation in the event of a loss of power.

The detector 140 can output the detection signal to a fire control panel 148, such as to cause the fire control panel 148 to output an alert indicative of the fire condition. As such, the sprinkler system 100 can be implemented so that the tube 116 can be at least partially flexible and free of fluid, and by electronically opening the fitting 112 responsive to detecting the fire condition. The detector 140 can be separate from (e.g., spaced from) the fluid distribution devices 128, while being within a threshold distance of the fluid distribution devices 128 to allow for sufficiently precise detection of the location of the fire and operation of fluid distribution devices 128 based on the detected location.

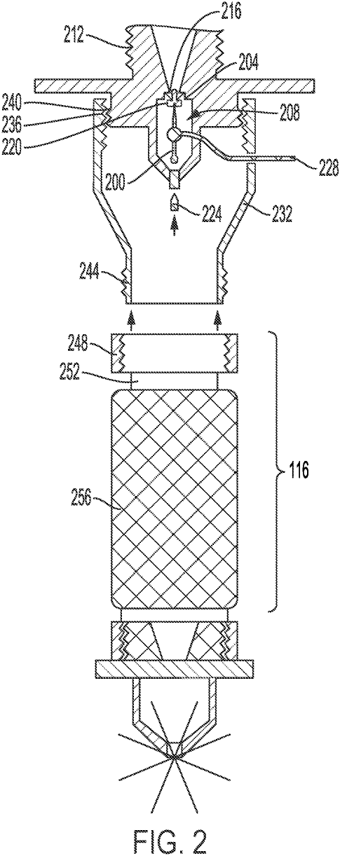

FIG. 2 depicts an example of the sprinkler system 100 in which the fitting 112 includes an electronically activated sealing element 200 (“element 200”). The fitting 112 can include a fitting body 204 that can extend around and define a chamber 208 around the element 200. The fitting body 204 can be connected with the pipes 108, such as by connecting an engagement member 212 (e.g., threads) of the fitting body 204 with the pipes 108. The element 200 can be used to implement the actuator 144.

The fitting body 204 can define an opening 216 that connects a fluid pathway from the pipes 108 with the chamber 208. The fitting 112 can include a seal 220 that seals the opening 216. For example, the seal 220 can include a button and a spring, such as a Belleville spring. The seal 220 can change from a closed state (in which the seal 220 seals the opening 216) to an open state (in which fluid is allowed to flow through the opening 216), enabling the fitting 112 to function as a valve.

The element 200 can contact the seal 220 (e.g., a downstream side of the seal 220 away from the opening 216), such as to apply a force against the seal 220 to hold the seal 220 in the opening 216. For example, the element 200 can be a bulb, such as a glass bulb, that can break responsive to energy applied to the element 200. Responsive to the element 200 breaking, the force applied by the element 200 against the seal 220 can decrease (e.g., no longer be present), such that pressure on the seal 220 from fluid in the pipes 108 can move the seal 220 out of the opening 216 to allow the fluid to flow through the fitting 112 into the tube 116. The fitting 112 can include a biasing element 224, such as a load screw or spring, that applies a force against at least one of the fitting body 204 and the element 200 to bias the element 200 towards the seal 220.

The actuator 144 can operate responsive to receiving the control signal through an electrical connection 228 (e.g., wired connection). The actuator 144 can be a mechanical actuator, such as a linear actuator, that moves responsive to the control signal from the detector 140 to break the element 200 to unseal the seal 220. The actuator 144 can be a pyrotechnic actuator. The element 200 can be a resistive bulb, such as by having electrical traces on an outer surface of the element 200, such that the electrical connection 228 can contact the electrical traces to provide electrical energy to the element 200 to cause the element 200 to break (e.g., by resistive heating of at least one of the element 200 and gases within the element 200 that can expand responsive to heating to break the element 200). The electrical connection 228 is depicted to be external to the tube 116; the electrical connection 228 can at least partially extend within the tube 116.

The fitting 112 can include at least one adapter 232. The adapter 232 can be coupled with the fitting body 204 and can facilitate coupling the pipe 108 with the tube 116, such as by including adapter threads 236 that engage fitting threads 240 of the fitting body 204. The adapter 232 can be used to change a diameter of the sprinkler system 100 from that of the pipes 108 to that of the tubes 116. As depicted in FIG. 2, the adapter 232 can include adapter threads 244 (e.g., at an outlet side opposite the fitting threads 240) to connect with the at least one tube 116, and the sprinkler system 100 can include an adapter 248 to connect a rigid member 252 (e.g., dry barrel; depicted as upstream of flexible hose 256 but may also be downstream of flexible hose 256) of the at least one tube with a flexible hose 256 of the at least one tube 116. The adapter 232 can be of various adapters or connectors, including grooved couplings, fittings that including sealing elements, such as gaskets, tee fittings, or elbow fittings.

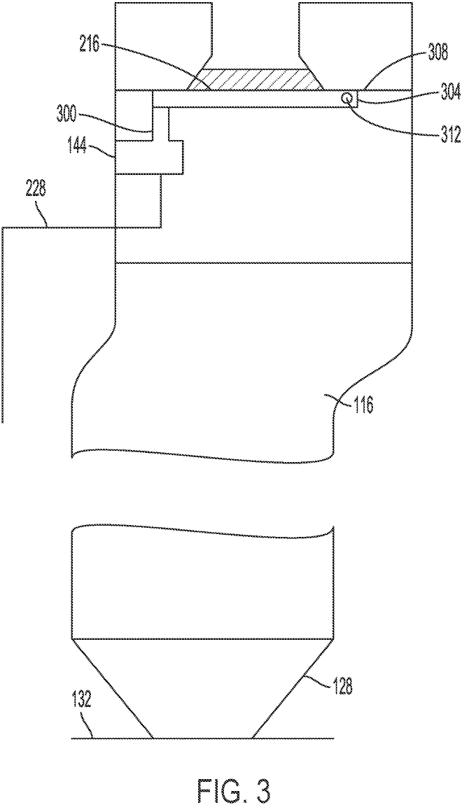

FIG. 3 depicts an example of the sprinkler system 100 in which the actuator 144 is coupled with a piston 300. The fitting 112 can include a hinge 304 that seals the opening 216 to prevent fluid in the pipes 108 from entering the tube 116. The hinge 304 can be mounted to an end wall 308 of the fitting 112 that defines the opening 216 at a pivot point 312 outward from the opening 216.

The piston 300 can contact the hinge 304 on an opposite side of the hinge 304 from the pivot point 312 (and on an opposite side of the hinge 304 from the opening 216). In a closed state of the hinge 304, the piston 300 can contact the hinge 304 to apply a force against the hinge 304 to hold the hinge 304 against the end wall 308 to prevent fluid flow out of the opening 216.

Responsive to receiving the control signal based on detection of the fire condition by the detector 140, the actuator 144 can cause the piston 300 to move away from the hinge 304, allowing the force applied by fluid in the pipes 108 to pivot the hinge 304 about the pivot point 312 so that the fluid can flow through the opening 216 and into the tube 116. For example, the actuator 144 can include a linear actuator or rotational actuator that moves to allow the piston 300 to be retracted away from the hinge 304.

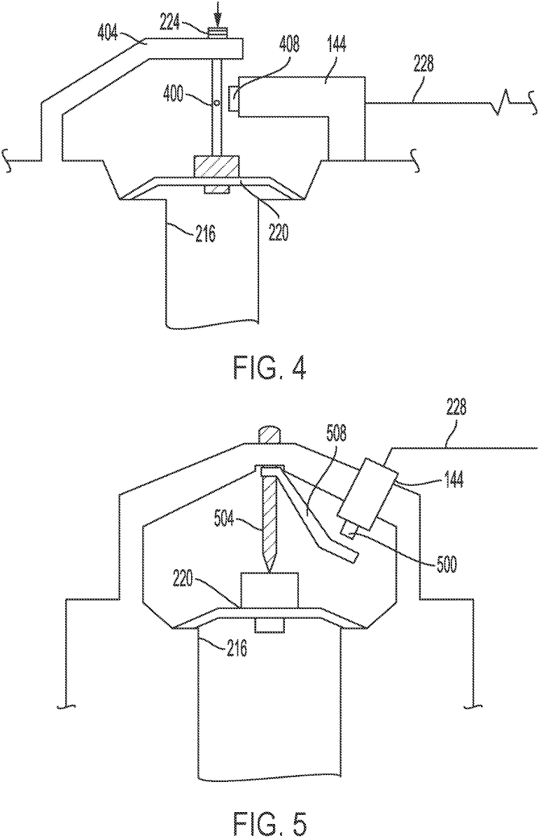

FIG. 4 depicts an example of the sprinkler system 100 in which the fitting 112 includes a hinge 400 that extends from a frame arm 404 to contact with the seal 220, which seals the opening 216. The fitting 112 can include the biasing element 224, which can apply a force against the hinge 400 to bias the hinge 400 towards the seal 220. The actuator 144 can receive the control signal and drive a piston 408 to move the hinge 400 responsive to receiving the control signal, causing the seal 220 to be opened to allow fluid to flow through the opening 216.

FIG. 5 depicts an example of the sprinkler system 100 that includes a driver 500 to unseal the opening 216 to allow fluid to flow into the tube 116. The fitting 112 can include a strut 504 in the chamber 208 that applies a force against the seal 220 to hold the seal 220 to seal the opening 216. The fitting 112 can include the biasing element 224 to apply a force against the strut 504 to facilitate holding the seal 220 to seal the opening 216.

The fitting 112 can include a lever 508 coupled with the strut 504. For example, as depicted in FIG. 4, the lever 508 can be coupled with and extend away from an outlet end (e.g., opposite opening 216) of the strut 504.

The actuator 144 can cause operation of the driver 500, which can include at least one of a piston and a thermal wax element. For example, the driver 500 can be implemented as the piston, and the actuator 144 can receive the control signal and drive the driver 500 to push the lever 508. Responsive to the driver 500 pushing the lever 508 (which is fixed with the strut 504), the strut 504 can be driven away from the seal 220 to allow the seal 220 to move out of the opening 216 and allow fluid to flow through the opening 216. The driver 500 can be implemented as the thermal wax element, and the actuator 144 can receive the control signal and use the electrical energy of the control signal to heat the thermal wax element, causing the thermal wax element to expand and push on the lever 508 to move the strut 504 to release the seal 220.

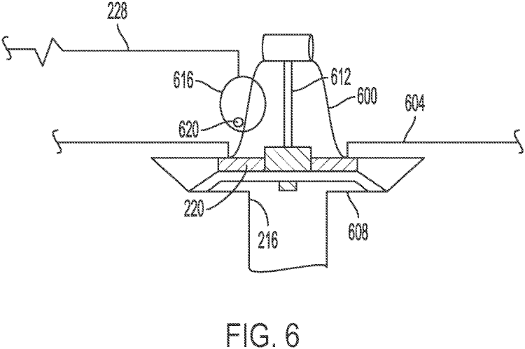

FIG. 6 depicts an example of the sprinkler system 100 that includes at least one spring arm 600. The spring arms 600 can be positioned between a first wall 604, which is spaced from a second wall 608 that defines the opening 216, and the seal 220. The spring arms 600 can be coupled with a strut 612 that extends between the spring arms 600 and contacts the seal 220. The spring arms 600 can apply a force against the seal 220 to hold the seal 220 in position to seal the opening 216.

As depicted in FIG. 6, the actuator 144 can be implemented using a rotary actuator 616 (e.g., wheel coupled with a motor) coupled with a boss 620. The boss 620 can be fixed with and extend outward from (e.g., in a direction parallel with a rotational axis of the wheel) the rotary actuator 616, so that an arc swept by the boss 620 responsive to rotation of the rotary actuator 616 causes the boss 620 to contact and push the spring arm 600.

All or part of the processes described herein and their various modifications (hereinafter referred to as “the processes”) can be implemented, at least in part, via a computer program product, i.e., a computer program tangibly embodied in one or more tangible, physical hardware storage devices that are computer and/or machine-readable storage devices for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks.

Computer program products are stored in a tangible form on non-transitory computer readable media and non-transitory physical hardware storage devices that are suitable for embodying computer program instructions and data. These include all forms of non-volatile storage, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks and volatile computer memory, e.g., RAM such as static and dynamic RAM, as well as erasable memory, e.g., flash memory and other non-transitory devices.

The construction and arrangement of the systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced. Other substitutions, modifications, changes, and omissions may be made in the design, operating conditions and arrangement of embodiments without departing from the scope of the present disclosure.

As utilized herein, the terms “approximately,” “about,” “substantially”, and similar terms are intended to include any given ranges or numbers +/-10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A sprinkler, comprising:
a fitting that connects with at least one pipe, the fitting defines an opening;
a seal that has a closed state in which the seal seals the opening and an open state in which the seal does not seal the opening to allow fluid flow from the at least one pipe through the opening;
at least one tube connected with the fitting downstream from the at least one pipe;
a fluid distribution device connected with the at least one tube; and
an actuator coupled with the fitting, the actuator receives a detection signal indicative of a trigger condition and causes the seal to change from the closed state to the open state to allow the fluid flow through the opening responsive to receiving the detection signal.

2. The sprinkler of claim 1, comprising:
a biasing element coupled with the fitting, the biasing element applies a force against the seal to hold the seal in the closed state.

3. The sprinkler of claim 1, comprising:
the at least one tube includes a flexible hose.

4. The sprinkler of claim 1, comprising:
the seal includes a hinge that is pivotably coupled with an end wall of the fitting that defines the opening; and
the actuator is coupled with a piston that applies a force to hold the hinge against the end wall, the actuator causes the piston to retract responsive to receiving the detection signal to allow the hinge to pivot to allow the fluid flow through the opening.

5. The sprinkler of claim 1, comprising:
a hinge that extends from a frame arm of the fitting towards the opening to apply a force against the seal; and
a piston coupled with the actuator that faces the hinge, the actuator causes the piston to move the hinge responsive to receiving the detection signal to move the hinge away from the seal.

6. The sprinkler of claim 1, comprising:
a strut that applies a force against the seal;
a lever coupled with the strut; and
a driver spaced from and facing the lever, the driver includes at least one of (i) a piston that the actuator drives and (ii) a thermal wax element that the actuator heats to expand the thermal wax element to move the lever to cause the strut to move away from the seal.

7. The sprinkler of claim 1, comprising:
at least one spring arm that holds the seal in the closed state; and
the actuator includes a rotary actuator coupled with a boss, the actuator rotates the boss to move the at least one spring arm responsive to receiving the detection signal to change the seal from the closed state to the open state.

8. The sprinkler of claim 1, comprising:
the fluid distribution device includes at least one of a sprinkler and a nozzle.

9. The sprinkler of claim 1, comprising:
the fluid distribution device is open between an inlet and an outlet.

10. The sprinkler of claim 1, comprising:
the fitting includes a fitting body that defines a chamber around the seal and a fitting adapter outward from the fitting body, the fitting adapter connects with the at least one tube.

11. The sprinkler of claim 1, comprising:
the at least one tube has at least one of air and nitrogen while the seal is in the closed state.

12. The sprinkler of claim 1, comprising:
the actuator comprises a thermal element in contact with the seal, the thermal element comprises electrical traces that receive an electrical signal corresponding to the detection signal and breaks responsive to heating by the electrical signal to change the seal from the closed state to the open state.

13. A sprinkler system, comprising:
a fitting that connects with at least one pipe, the fitting defines an opening and includes a seal, the seal has a closed state in which the seal seals the opening and an open state in which the seal does not seal the opening to allow fluid flow from the at least one pipe through the opening;
at least one tube that connects with the fitting downstream from the at least one pipe;
at least one fluid distribution device connects with the at least one tube;
a detector that monitors at least one parameter of an environment around the sprinkler assembly and outputs a detection signal responsive to the at least one parameter satisfying a trigger condition; and
an actuator that receives the detection signal and causes the seal to change from the closed state to the open state to allow the fluid flow through the opening responsive to receiving the detection signal.

14. The sprinkler system of claim 13, comprising:
a fire control panel that outputs an alert responsive to the detector detecting the trigger condition.

15. The sprinkler system of claim 13, comprising:
the detector comprises at least one of a temperature sensor and a gas sensor.

16. The sprinkler system of claim 13, comprising:
the detector is spaced from the at least one fluid distribution device and outputs the detection signal as an electrical signal using a wired electrical connection with the actuator.

17. The sprinkler system of claim 13, comprising:
the at least one tube includes a flexible hose.

18. The sprinkler system of claim 13, comprising:
the at least one fluid distribution device includes at least one of a sprinkler and a nozzle that is open between an inlet and an outlet.

19. The sprinkler system of claim 13, comprising:
the at least one tube has at least one of air and nitrogen while the seal is in the closed state.

20. The sprinkler system of claim 13, comprising:
the at least one tube includes at least one of a rigid tube having a stiffness greater than a threshold stiffness and a flexible tube having a stiffness less than the threshold stiffness.
